(19) United States
(12) Patent Application Publication
(10) Pub. No.: US 2015/0135250 A1
(43) Pub. Date: May 14, 2015

(54) COLOR SYNCHRONIZER FOR STREAMING MEDIA

(71) Applicant: J. Michael James, Pleasanton, CA (US)

(72) Inventor: J. Michael James, Pleasanton, CA (US)

(21) Appl. No.: 14/521,433

(22) Filed: Oct. 22, 2014

Related U.S. Application Data
(60) Provisional application No. 61/894,323, filed on Oct. 22, 2013.

(51) Int. Cl. H04N 21/258; H04N 21/238; H04N 21/2343

(52) U.S. Cl. CPC H04N 21/25825; H04N 21/23439; H04N 21/238
USPC 725/116

(57) ABSTRACT

Preferred embodiments of the invention include methods and systems for color synchronizing streaming media. Preferred methods and devices for synchronizing colors across one or more viewing devices with various color characteristics are provided, including measuring the one or more viewing devices to determine the color characteristics of the viewing devices, and entering the color characteristics into a database, wherein the database includes records of the color characteristics of the viewing devices. Also is provided a database comprising values that are associated with viewing devices having color characteristics, wherein the values represent the color characteristics of the viewing devices. Further embodiments of the invention include a method of providing streaming media content having different color characteristics to viewing devices having different color characteristics so that the streaming media content appears to be the same colors on the viewing devices, comprising identifying viewing devices with various color characteristics, determining the color characteristics of the viewing devices, selecting streaming media content having different color characteristics based on the color characteristics of the viewing devices, and optionally providing the streaming media content to each of the viewing devices, or adjusting the color settings of the streaming media content according to the color characteristics of the viewing device, or modifying the color of the streaming media content according to the viewing devices color characteristics as defined in the database.

### CROSS-REFERENCE TO RELATED APPLICATIONS

This application claims the benefit of U.S. Provisional Patent Application No. 61/894,323, filed Oct. 22, 2014, the entirety of which is incorporated by reference as if fully set forth herein.

### FIELD OF THE INVENTION

Embodiments of the invention relate to systems and methods for color synchronization for digital media streams that are viewed on user devices.

### BACKGROUND OF THE INVENTION

A common problem with streaming film or video content sent to computer displays and mobile devices for viewing is that content producers design their content to be viewed on a display with a fixed set of color characteristics that have been standardized by the film and video industry. Most TVs have the correct target colors. Computer and mobile devices are optimized for a variety of applications and have a variety of possible display color characteristics. When film or video content is produced for a specific type of color display and it is shown on one with different characteristics it can be visually distorted.

Color Synchronizer for Streaming Media is a solution to this common problem. An embodiment of this invention is optimized to resolve the color issues for streaming video. A database of color characteristics is developed for the various types of computer and mobile display devices. The servers that deliver the content can determine what device is being used as a viewer. The viewing device is compared to the database. Based on the categorization in the database of the viewing device one of a number of different streams are provided to the viewing device. As an example, if the device has over-saturated colors then a stream is sent that has less saturated colors. The result is that the inaccurate color characteristics of the device are compensated for by the color characteristics of the color encoding of the server stream. The artistic intent of the content producer is maintained. The user sees the film or video content in more accurate and correct colors.

### SUMMARY OF THE PREFERRED EMBODIMENTS OF THE INVENTION

Preferred embodiments of the invention include methods and systems for color synchronizing streaming media. Preferred methods and devices for synchronizing colors across one or more viewing devices with various color characteristics are provided, including measuring the one or more viewing devices to determine the color characteristics of the viewing devices, and entering the color characteristics into a database, wherein the database includes records of the color characteristics of the viewing devices. Also provided is a database comprising values that are associated with viewing devices having color characteristics, wherein the values represent the color characteristics of the viewing devices. Further embodiments of the invention include a method of providing streaming media content having different color characteristics to viewing devices having different color characteristics so that the streaming media content appears to be the same colors on the viewing devices, comprising identifying viewing devices with various color characteristics, determining the color characteristics of the viewing devices, selecting streaming media content having different color characteristics based on the color characteristics of the viewing devices, and optionally providing the streaming media content to each of the viewing devices, or adjusting the color settings of the streaming media content according to the color characteristics of the viewing device, or modifying the color of the streaming media content according to the viewing devices color characteristics as defined in the database.

### BRIEF DESCRIPTION OF THE DRAWINGS

FIG. 1 provides an example of a typical calibration report.

FIG. 2 provides an example gamut chart for database entries that are in the wide gamut category.

FIG. 3 provides an example gamut chart for database entries that are in the standard gamut category.

FIG. 4 provides an example gamut chart for database entries that are in the reduced gamut category.

FIG. 5 provides an example of the steps taken in an embodiment of the invention to synchronize color for streaming media.

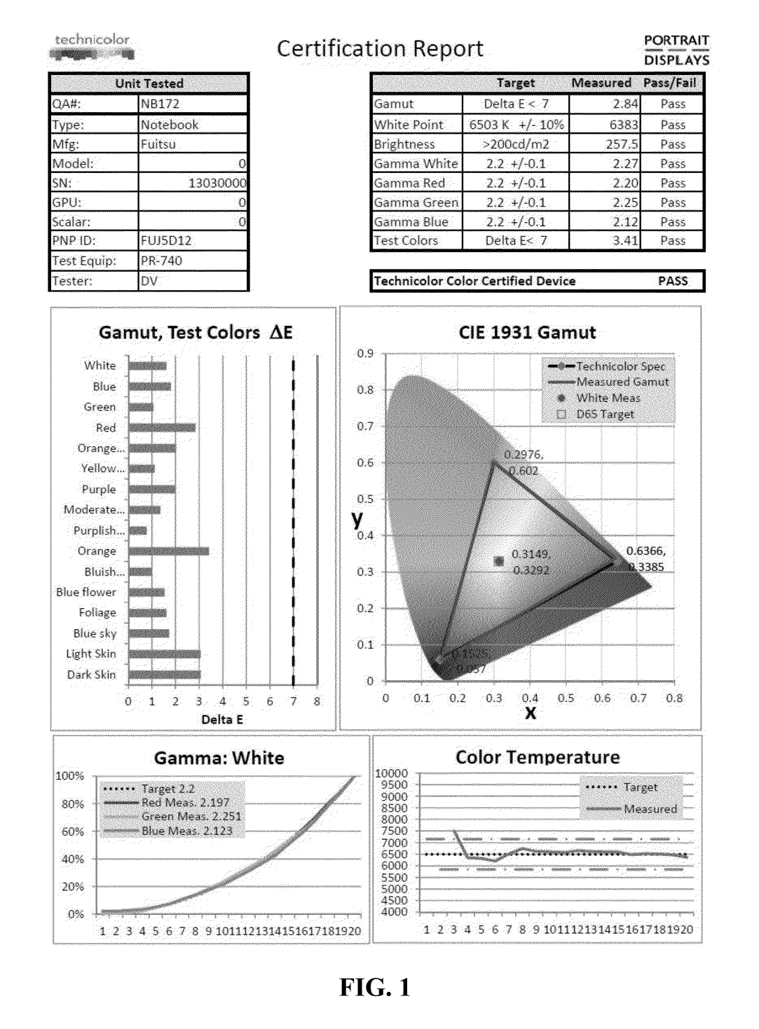

Regarding FIG. 1, client displays are measured with scientific instrumentation to determine their color characteristics. Color chromaticity values, gamma values, and white point values are measured. FIG. 1 provides an example of a typical calibration report for this process.

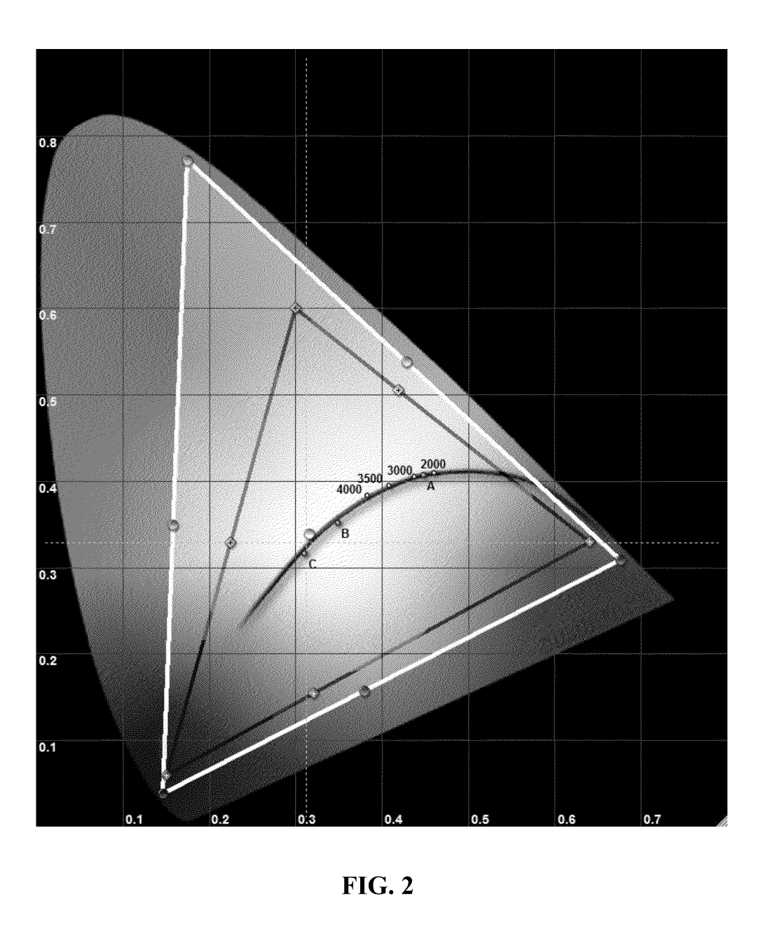

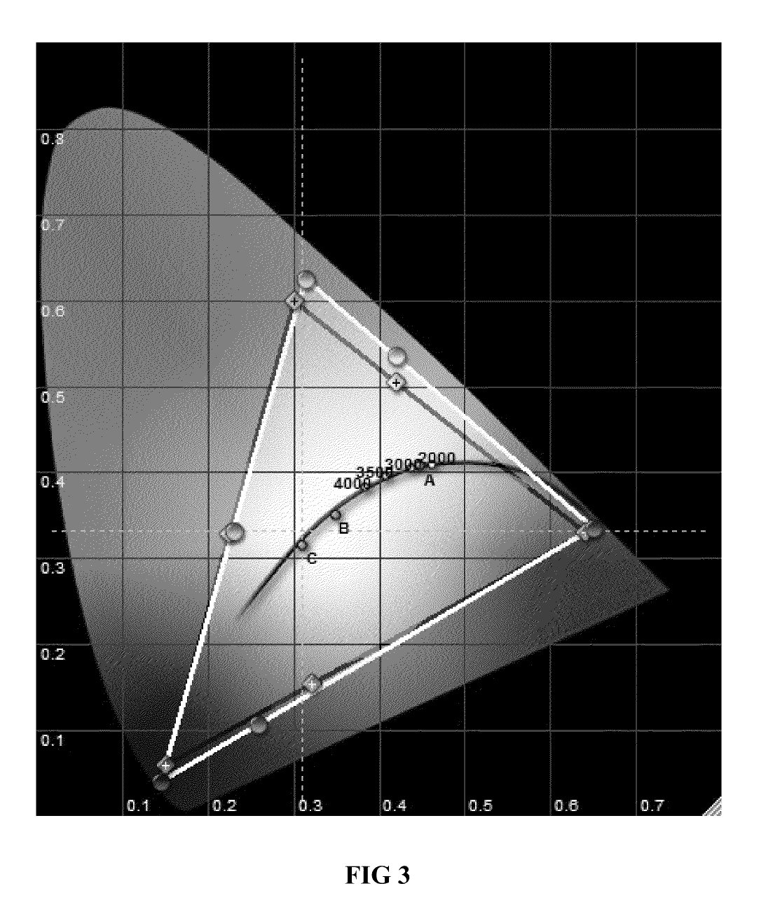

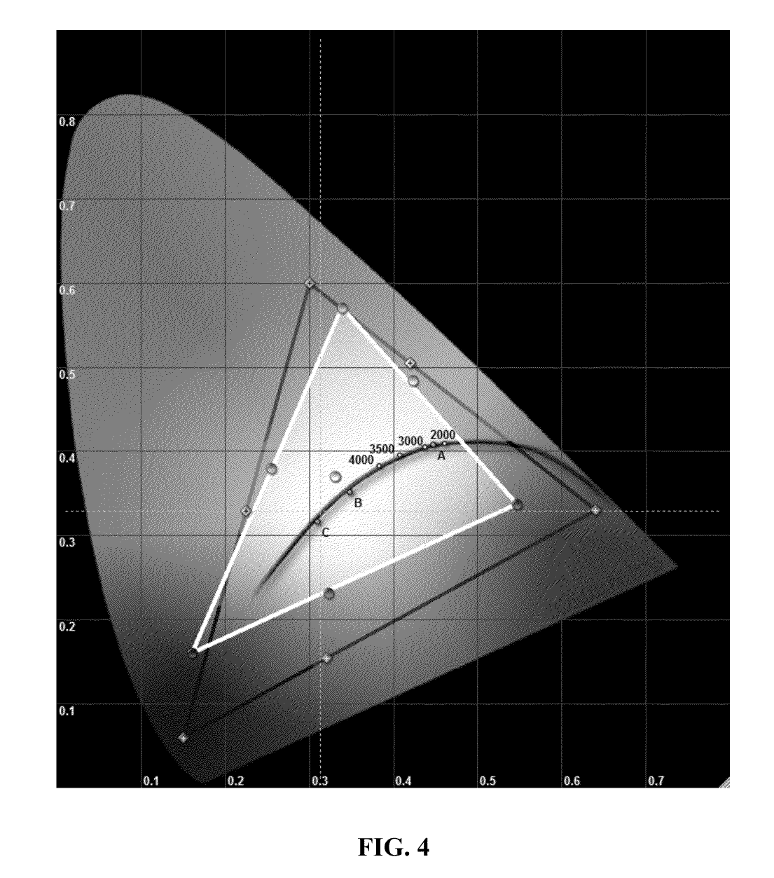

Regarding FIGS. 2-4, the “horse shoe” shaped charts represents all the colors the human eye can see. The dark lines on the charts are the REC709 standard for color gamut. The white lines are the measured colors of the target display. The measurements are always a triangle made up of the absolute measurements of Red, Green, and Blue. The only colors visible to the user of the display are those that fall with-in the triangle. Colors outside the triangle are not displayed.

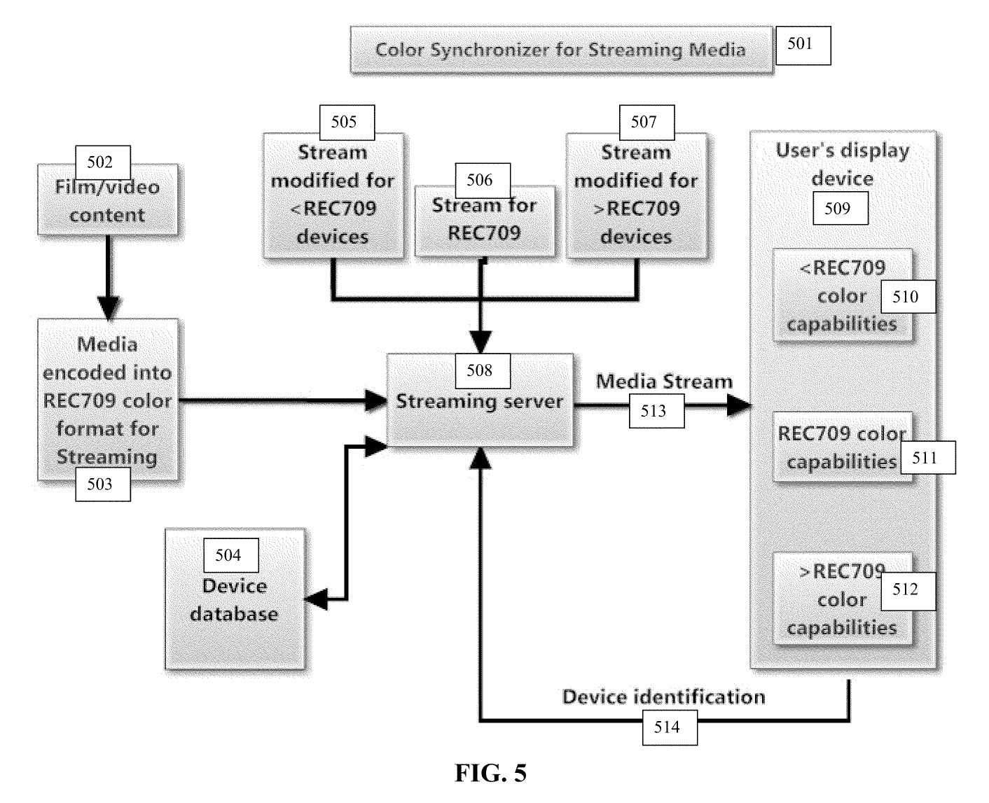

Regarding FIG. 5, a flow chart is provided to detail the steps to achieve color synchronization for streaming media 501 in one embodiment of the invention, which such steps may include the following. Client displays 509 are measured with scientific instrumentation to determine their color characteristics 510-512. Color chromaticity values, gamma values, and white point values are measured 514. These values are entered into a database 504, which such database entries may be divided into three, or more, categories, such as wide gamut, standard gamut, and reduced gamut FIGS. 2-4. When a user goes onto the Web to a streaming service 508 (such as Blockbuster, Amazon, hulu, Netflix, iTUNES, HBO Go, Showtime Anytime, etc.), which provides film/video content 502 in a number of streams 513 with different color characteristics 505-507, and which can determine what device 509 with what color capabilities 510-512 is being used for viewing 514, the streaming service 508 compares the viewing device 509 with the entries in a database 504. Based on which category of device is being used 510-512 for viewing the service 508 sends the appropriate stream 505-507. If a viewing device 509 is not on the list 504 then the default is to send the standard REC709 color stream 503. If the viewing device is a standard TV the REC709 stream 503 is sent. The system is automatic and does not require any intervention by the user. However, the user could also have the ability to decide which of the streams they want to receive.

### DETAILED DESCRIPTION

What is streaming video?

Streaming video is film or video content sent over the Internet by a server and displayed on a client computer display or mobile device via a media player or viewer. A Web user does typically not have to wait to download a file to view it. The media is sent in a continuous stream of data and is available for viewing on the client as it arrives at the user's device. The client device must have a media player or viewer that uncompresses and sends video data to the display and audio data to speakers.

Color Problems

Human perception of color is complicated. It is composed of three primaries; Red, Green and Blue. Each of these primaries has two independent variables in saturation and brightness. And, all these variables interact. The human eye can see over 16 million different colors and is very sensitive to even minor color differences. There are specific colors that people remember; flesh tones, faces, and the color of grass and the sky are of a known color. If the user of a display sees these colors as different from what they remember, the colors on the display look incorrect.

Definition of the Problem

The issue in media streaming has to do with the different color characteristics designed into the media content at the server end and the way that media is displayed by the client device. The client display is the screen on the computer or mobile device being viewed by the user.

1. The client display can be on a TV, monitor, a notebook computer, a tablet computer, or a smart phone or any combination of these devices. All of these devices consist of a display driven by a computer. The invention requires the computing device to be connected to the Internet and used for viewing streamed media.

2. The server streams the media prepared by the content producer, director, cinematographer and/or colorist. The content is captured and prepared for viewing based on a specific set of color standards. The standard is REC709. This defines the color calibration in absolute values. The content to be streamed is edited and prepared on displays calibrated to REC709.

Both the content developer and the client displays represent the colors in the content based on their color characteristics. These color characteristics include:

1. Red, blue, and green color, which are the chromaticity or gamut of the display.

2. White point, which is the color value of the maximum white level.

3. Gamma, which is the non-linear relationship between the increase in a value of the red, blue, or green signal and the increase in the red, blue, or green brightness or luminous.

The result of a difference in color characteristics of the display used to develop the content and the display used to view the content will be that the content being viewed by the user will be distorted.

As an example, a director designs a production to be viewed on a display meeting the REC709 standard of color accuracy. If an actor's face is shown on a display with too little color gamut it will look grey and lack color. If it is shown on a display with too much color gamut it will look reddish and the actor may appear sun-burned or flushing.

The Color Synchronizer for Streaming Media Process

An embodiment of the invention synchronizes the color of the content being streamed to the color characteristics of the user's display. To accomplish this, a number of steps are implemented:

1. Client displays are measured with scientific instrumentation to determine their color characteristics. Color chromaticity values, gamma values, and white point values are measured.

2. These values are entered into a database. As an example all database entries may be divided into three, or more, categories; Wide gamut, standard gamut, and reduced gamut. Example gamut charts for three categories of color capabilities are “horse shoe” shaped because they represent all the colors the human eye can see. The charts have dark lines, which are the REC709 standard for color gamut, and a white line, which is the measured colors of the target display. The measurements are always a triangle made up of the absolute measurements of Red, Green, and Blue. The only colors visible to the user of the display are those that fall with-in the triangle.

3. The streaming services such as; Blockbuster, Amazon, hulu, Netflix, iTUNES, HBO Go, Showtime Anytime, etc., would provide a number of streams with different color characteristics. As an example one can be provided for devices with over saturated colors, one for correct colors and one for reduced color gamuts.

4. The streaming service may decide to have only a single stream but alter it through filtering before it is sent to the client. In this instance the color characteristics are changed dynamically as it is streamed.

5. When the user goes onto the Web to a streaming service, the streaming service can determine what device is being used for viewing. The streaming service compares the viewing device with the entries in a database. Based on which category of device is being used for viewing the service sends the appropriate stream.

6. If a viewing device is not on the list then the default is to send the standard REC709 color stream.

7. If the viewing device is a standard TV to REC709 stream is sent.

8. The system is automatic and does not require any intervention by the user. However, the user could also have the ability to decide which of the streams they want to receive.

Altering Color Characteristics

Color is complex and made up of many elements. The following are examples of what changes can be made in a content stream to improve the viewing experience of the streaming service user. The categories are used in the example:

1. Over saturated displays:

This is the kind of display that has a wider color gamut than the REC709 standard. Some combination of the RED, GREEN or BLUE maximum colors are too saturated. OLED displays, wide gamut displays, AdobeRGB-compatible, RGB back-lit LED displays are examples of over saturated screens.

The following are examples of the color changes that could be made:
Saturation reduced by 30%
Brightness increased by 15%
Color temperature moved toward red by 5%

2. Accurately calibrated REC709 displays:

This is the kind of display that has a color gamut close to the REC709 standard.

3. Under saturated displays:

This is the kind of display that has a smaller color gamut than the REC709 standard. These are the most common shipping displays.

The following are examples of the color changes that could be made:
Saturation increased by 9%
Brightness increased by 35%
Color temperature moved toward red by 7%
White level increased by 7%
Gamma increased by 10%

No display has perfect colors. The acceptable variation are determined by the manager of the streaming Web site. Each characterized display is put into the category to which it's color characteristics most match.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

1. A method of providing streaming media content having different color characteristics to viewing devices having different color characteristics so that the streaming media content appears to be the same colors on the viewing devices, comprising:
identifying viewing devices with various color characteristics;
determining the color characteristics of the viewing devices;
selecting streaming media content having different color characteristics based on the color characteristics of the viewing devices; and
providing the streaming media content to each of the viewing devices, wherein when the colors in the streaming media content appear to be the same on each viewing device.

2. The method of claim 1 wherein determining the color characteristics of the viewing device occurs by consulting a database containing color characteristic information for viewing devices.

3. The method of claim 1 wherein the streaming media color settings are adjusted according to the color characteristics of the viewing device.

4. A method of adjusting the color of streaming media content post-production, comprising:
identifying a viewing device with color characteristics and determining the value of the color characteristics by consulting a database containing color characteristics of various viewing devices;
modifying the color of the streaming media content according to the viewing devices color characteristics as defined in the database.

5. The method of claim 6, wherein the post-production modification of the color of the streaming media content may be performed by an internet service.

6. A streaming media content service for providing streaming media content to viewing devices having various color characteristics, whereby the streaming service:
determines what viewing device is presenting the streaming media content;
compares the viewing device against a database containing entries listing viewing devices having various color characteristics and assigns the viewing device to a category;
adjusts the color of the streaming media content depending on the category assigned to the viewing device; and
provides the streaming media content with adjusted color to the viewing device.
